(19) United States
(12) Patent Application Publication
(10) Pub. No.: US 2023/0249202 A1
(43) Pub. Date: Aug. 10, 2023

(54) BEARING SYSTEM FOR A ROTARY ATOMIZER

(71) Applicant: Dürr Systems AG, Bietigheim-Bissingen (DE)

(72) Inventors: Arved Hess, Konstanz (DE); Tobias Kleinhans, Benningen (DE)

(21) Appl. No.: 18/015,140

(22) PCT Filed: Aug. 2, 2021
(86) PCT No.: PCT/EP2021/071526

§ 371 Date: Jan. 9, 2023

(30) Foreign Application Priority Data
Aug. 4, 2020 (DE) 10 2020 120 536.8

(51) Int. Cl. B05B 3/10

(52) U.S. Cl. CPC B05B 3/1035; B05B 3/1014

(57) ABSTRACT

The disclosure relates to a bearing system for a drive turbine of a rotary atomizer, having a rotatable turbine shaft for receiving a bell cup which is used for spraying off the paint, and having a radial bearing for rotatably supporting the turbine shaft. The disclosure provides that the radial bearing has at least one foil bearing or a spiral groove bearing.

### CROSS-REFERENCE TO RELATED APPLICATIONS

This application is a national stage of, and claims priority to, Patent Cooperation Treaty Application No. PCT/EP2021/071526, filed on Aug. 2, 2021, which application claims priority to German Application No. 10 2020 120 536.8, filed on Aug. 4, 2020, which applications are hereby incorporated herein by reference in their entireties.

### FIELD

The disclosure relates to a bearing system for a drive turbine of a rotary atomizer.

### BACKGROUND

In modern painting installations for painting motor vehicle body components, a rotary atomizer is usually used as an application device. A so-called bell cup rotates at high speed and spins the paint to be applied off a spray-off edge of the bell cup. The bell cup is driven by a compressed air turbine with a rotatably mounted turbine shaft, which carries the bell cup at its end. The turbine shaft is usually supported by aerostatic air bearings.

One disadvantage of using aerostatic air bearings to support the turbine shaft is that compressed air with a high degree of purity is required, i.e. with a low oil content and a small number and size of solid particles.

Another disadvantage of the known air bearings is their sensitivity to an impact force.

Furthermore, the known air bearings also have only limited emergency running properties.

For the technical background of the disclosure, reference should also be made to US 2003/0169951 A1, U.S. Pat. No. 9,970,481 B1 and the Wikipedia articles “Spiral groove bearing” and “Foil bearing”.

### BRIEF DESCRIPTION OF THE DRAWINGS

FIG. 1 shows a schematic cross-sectional view through a rotary atomizer according to the disclosure.

FIG. 2 shows a front view of the stationary disc of the spiral groove bearing of the rotary atomizer from FIG. 1.

FIG. 3A shows a schematic cross-sectional view of another embodiment of a rotary atomizer according to the disclosure.

FIG. 3B shows an enlarged detailed view of FIG. 3A.

FIG. 4A shows a variation of the embodiment according to FIG. 3A.

FIG. 4B shows an enlarged detail view from FIG. 4A.

FIG. 5 shows a simplified schematic cross-sectional view of a foil bearing according to the disclosure.

FIG. 6 shows a modification of the film bearing in FIG. 6.

FIG. 7 shows a schematic cross-sectional view of a spiral groove bearing for use as an axial bearing.

FIGS. 8-10 show various variations of the embodiment according to FIG. 1.

### DETAILED DESCRIPTION

The bearing system according to the disclosure comprises a rotatable turbine shaft which serves to receive a bell cup, the bell cup being able to be screwed onto the end of the turbine shaft, for example, as is known per se from the prior art.

Furthermore, in accordance with the prior art, the bearing system according to the disclosure also comprises at least one radial bearing for rotatably supporting the turbine shaft.

The disclosure is characterized in that the radial bearing comprises at least one foil bearing. The at least one foil bearing supports the turbine shaft in a rotary atomizer. One feature is the large operating range in terms of speeds and a low available starting torque of the atomizer turbine.

Alternatively, it is also possible for the radial bearing to be formed by at least one spiral groove bearing, such bearings also being referred to as spiral slot bearings.

In a preferred embodiment of the disclosure, the foil bearing first comprises a cover foil which is substantially cylindrical or free-formed and surrounds the turbine shaft.

In addition, the foil bearing preferably comprises a spring foil that is substantially cylindrically shaped and at least partially surrounds the cover foil, wherein the spring foil exerts a radially inwardly directed spring force on the cover foil.

For example, the spring foil may have a surface stiffness of substantially 10⁹ N/m³, with variations of ±50%, ±25%, ±10%, or ±5% possible.

Furthermore, the foil bearing preferably has a bearing shell that encases the spring foil on the outside, whereby the spring foil is supported on the outside of the bearing shell and presses radially inwards onto the cover foil. The bearing shell can, for example, be cylindrically shaped or have several circular arcs.

For example, the spring foil can be formed as a wire mesh, as a corrugated foil with protruding bumps, as a metal foil with curved structures, or as an elastomer foil, to name just a few examples.

Furthermore, the spring foil can be manufactured by etching, although other manufacturing methods are also possible.

Furthermore, the cover foil may be coated with a wear-reducing coating on the turbine shaft side (i.e., inside) to reduce friction and wear during operation.

Furthermore, the bearing shell and the cover foil can have different radii distributed over the circumference, as is also known, for example, from hydrodynamic bearings.

The turbine shaft is preferably driven mechanically by means of a compressed air turbine with a rotatable turbine wheel. For this purpose, the compressed air turbine has a drive air supply to supply drive air for driving the turbine wheel. In addition, the compressed-air turbine has an exhaust air guide for discharging the expanded drive air from the compressed-air turbine, as is known per se from the prior art.

In this case, the supplied drive air and/or exhaust air can also be partially guided through the foil bearing, for example radially from the outside to the inside. For this purpose, the drive air supply can branch off part of the drive air and guide it through the foil bearing.

In addition, the expanded drive air from the exhaust air supply can also be directed through the foil bearing, for example in an axial direction.

The spring foil, the cover foil and/or the bearing shell can therefore have radially through-going holes to allow the branched-off drive air to be passed radially from the outside to the inside.

In a preferred embodiment of the disclosure, the radial bearing comprises not only a single foil bearing, but at least two foil bearings which are adjacent to one another in the axial direction or are spaced apart from one another, it being possible, for example, for a spacer ring to be located between the adjacent foil bearings.

For example, the two foil bearings can also be arranged on different sides of the turbine wheel of the compressed air turbine. In contrast, in another embodiment of the disclosure, the two foil bearings are located on the same side of the turbine wheel of the compressed air turbine.

The above description relates essentially to the design of the radial bearing as a foil bearing. Furthermore, the bearing system according to the disclosure preferably has an additional axial bearing to support the turbine shaft also in the axial direction. This axial bearing is preferably designed as an aerodynamic spiral groove bearing, whereby such spiral groove bearings are known from the prior art. For example, reference should be made to the Wikipedia article “Spiral groove bearing”.

Thus, the spiral groove bearing preferably first comprises a rotating disc which is connected to the turbine shaft in a rotationally rigid manner and rotates with the turbine shaft during operation. In addition, the spiral groove bearing comprises a first stationary disc that is stationarily arranged in the bearing system, wherein the rotating disc and the first stationary disc are adjacent to each other in a substantially plane-parallel manner. In the end face of the first stationary disc there are then preferably spiral grooves, as is known per se from conventional spiral groove bearings.

In a preferred embodiment of the disclosure, the spiral groove bearing additionally comprises a second stationary disc which is arranged in a stationary manner in the bearing system, the rotating disc and the second stationary disc adjoining one another in a substantially plane-parallel manner. A plurality of spiral grooves are also arranged in the end face of the second stationary disc on the side of the rotating disc or the stationary disc, as is known from conventional spiral groove bearings and therefore need not be described in detail.

The two stationary discs are preferably preloaded against each other in the axial direction, i.e. pressed together, by at least one spring.

Between the two stationary discs there is preferably a spacer (e.g. spacer bolt), the spacer adjusting the axial distance between the two stationary discs in order to reduce the starting friction.

The aforementioned rotating disc of the spiral groove bearing can, for example, be formed by the turbine wheel or be torsionally rigidly connected to the turbine wheel. In the preferred embodiment of the disclosure, a spiral groove bearing is arranged on both sides of the turbine wheel. In this way, the axial bearing also acts as a seal and reduces the leakage losses of the turbine.

In one variant of the disclosure, the bearing shell of the foil bearing has an inner cross section that is essentially constant in the axial direction, while the cover foil of the foil bearing has an inner cross section that tapers in the circumferential direction and thus forms several wedges. This can be formed by the bearing shell as well as by the shape of the spring foil.

In another variant of the disclosure, on the other hand, the bearing shell and the cover foil of the foil bearing each have an inner cross-section which tapers in the axial direction towards the bell cup, in particular in a conical shape.

In general, the bearing system according to the disclosure preferably generates a heating power during operation by frictional heat, which is at least 50 W, 100 W, 200 W or 300 W, in order to avoid condensation in the bearing system.

Furthermore, the spring foil of the foil bearing allows a certain radial spring travel, while the spring foil has a certain bearing diameter, the ratio between the spring travel and the bearing diameter preferably being smaller than 0.1, 0.05, 0.01, 0.005 or 0.0033.

Furthermore, it should be noted that the bearing system for sealing the rotatable turbine shaft may comprise a labyrinth seal, which preferably annularly surrounds the turbine shaft and is arranged at the distal end of the turbine shaft, i.e. in front of the mounting possibility for the bell cup.

In the bearing system according to the disclosure, the radial bearing can have an aerostatic air bearing, in which supplied compressed air builds up an air cushion for the bearing. Alternatively, however, it is also possible for the radial bearing to have an aerodynamic air bearing, in which an air cushion for the bearing is generated by the movement of the air bearing.

The disclosure does not only claim protection for the bearing system described above. Rather, the disclosure also claims protection for a complete rotary atomizer having such a bearing system for supporting the turbine shaft.

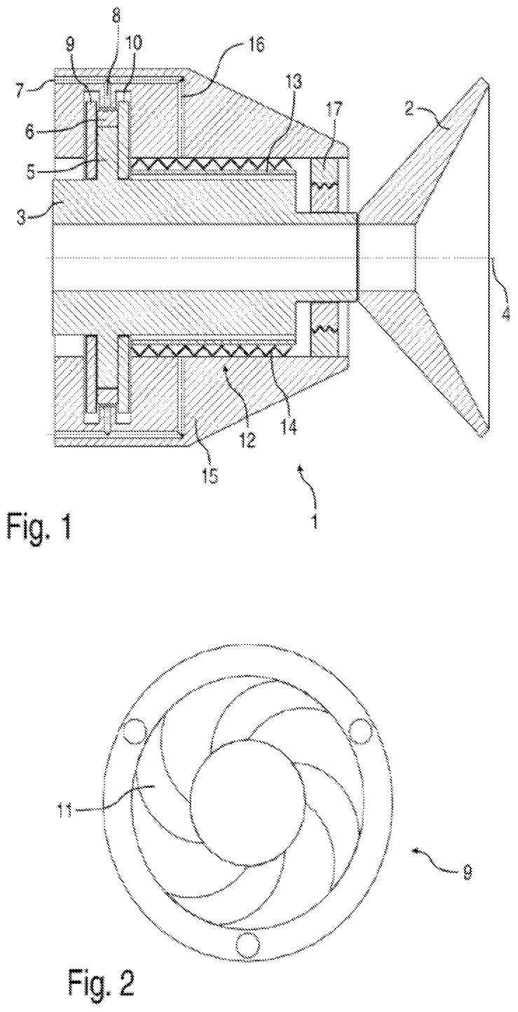

FIG. 1 shows a simplified, schematic representation of a rotary atomizer 1 according to the disclosure, which can be used, for example, to dispense the paint to be applied in a painting system for painting motor vehicle bodies. For this purpose, the rotary atomizer 1 comprises a bell cup 2 which is mounted on a turbine shaft 3 and rotates at high speed about a rotation axis 4 during painting operation.

The rotary atomizer 1 is conventionally driven by a compressed air turbine with a turbine wheel 5 projecting radially from the turbine shaft 3 and carrying turbine blades 6 at its end. In operation, the turbine wheel 5 with the turbine blades 6 is flowed against by drive air supplied by an air supply 7. In the rotary atomizer 1, a drive air line 8 branches off from the air supply 7 and is directed at the turbine blades 6.

In the axial direction, the turbine wheel 5 is adjoined by two stationary discs 9, 10, which lie plane-parallel against the end faces of the turbine wheel 5 and together with the turbine wheel 5 form a spiral groove bearing for axial supporting of the turbine shaft 3. For this purpose, the two stationary discs 9, 10 each have spiral grooves 11 on the side facing the turbine wheel 5, as shown in FIG. 2 with reference to the stationary disc 9. Together with the turbine wheel 5, the two stationary discs 9, 10 thus form an axial bearing within the rotary atomizer 1.

In addition, the rotary atomizer 1 also contains a radial bearing for supporting the turbine shaft 3. The radial bearing is designed as a foil bearing 12 and comprises a cover foil 13, a spring foil 14 and a bearing shell 15, the bearing shell 15 being formed by the atomizer housing. The spring foil 14 is mounted between the bearing shell 15 and the cover foil 13. The spring foil 14 is supported on the outside of the bearing shell 15 and presses the cover foil 13 inwards. The foil bearing 12 as a general proposition is known in principle from the prior art in its construction and mode of operation and therefore need not be described in detail.

One advantage of the novel use of the foil bearing 12 in the rotary atomizer 1 is its lower sensitivity to impact-like force effects.

A bearing air line 16 branches off from the air supply 7 in order to introduce part of the drive air into the foil bearing 12, radially from the outside to the inside.

Furthermore, the rotary atomizer 1 has a labyrinth seal 17 at the distal end of the turbine shaft but within the rotary atomizer 1.

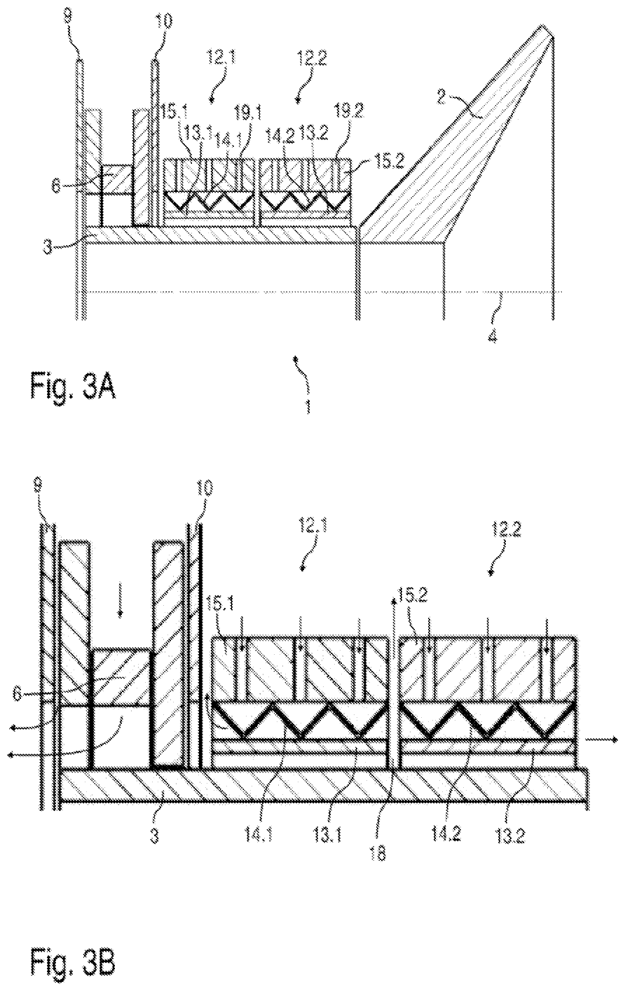

FIGS. 3A and 3B show cross-sectional views through another embodiment of a rotary atomizer 1 according to the disclosure, this embodiment largely corresponding to the embodiment described above and illustrated in FIGS. 1 and 2, so that reference is made to the above description in order to avoid repetition, the same reference signs being used for corresponding details.

A special feature of this embodiment is that two foil bearings 12.1, 12.2 are provided to support the turbine shaft 3. In this case, the two foil bearings 12.1, 12.2 are arranged next to each other in the axial direction and enclose only an air gap 18 between them, the function of the air gap 18 being described in detail below.

The two foil bearings 12.1, 12.2 each have a bearing shell 15.1, 15.2, wherein the two bearing shells 15.1, 15.2 each have radially extending through bores 19.1, 19.2 in order to be able to pass the bearing air supplied via the bearing air line 16 in the radial direction through the bearing shell 15.1, 15.2, as shown by the arrows. The supplied bearing air can then escape again through the air gap 18, as also shown by the arrow.

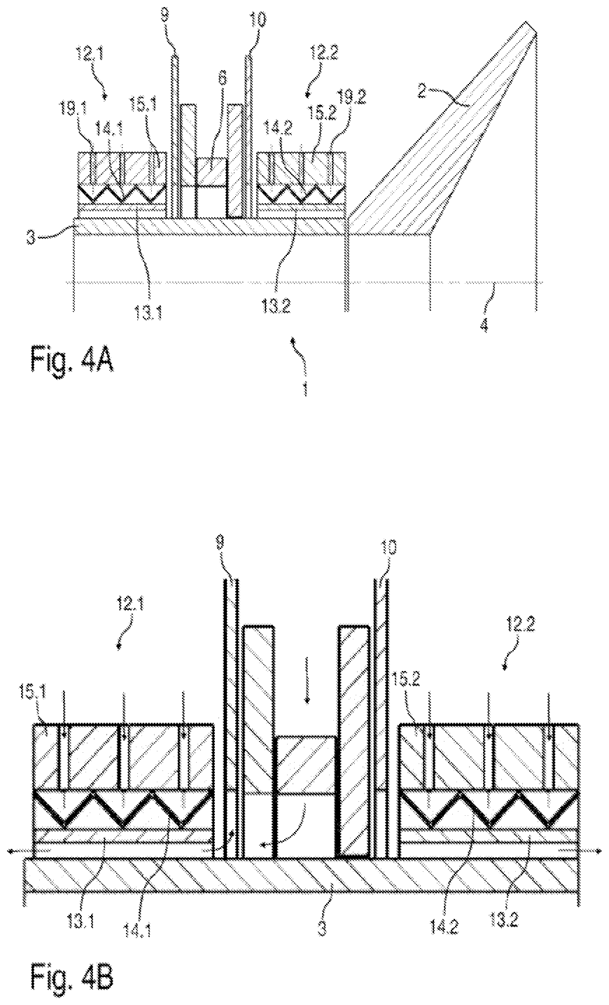

FIGS. 4A and 4B show a variation of the embodiment according to FIGS. 3A and 3B, so that reference is made to the above description for FIGS. 3A and 3B in order to avoid repetition. A special feature of this embodiment is that the two foil bearings 12.1, 12.2 are arranged on different sides of the turbine wheel 5.

Furthermore, it can be seen from FIG. 4B that a part of the expanded exhaust air of the compressed air turbine can be conducted through the foil bearings 12.1, 12.2.

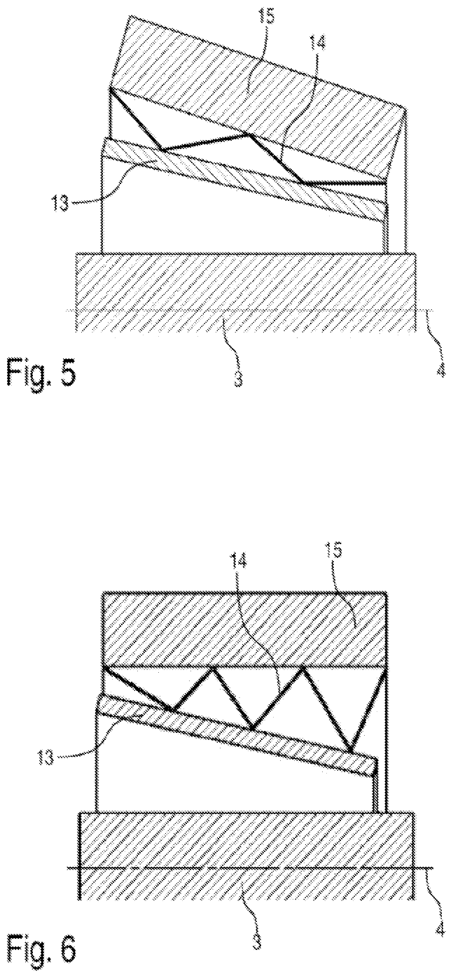

FIG. 5 shows a simplified, schematic cross-sectional view of a foil bearing 12 according to the disclosure, which largely corresponds to the embodiments of foil bearings 12 described above, so that in order to avoid repetition, reference is made to the previous description, the same reference signs being used for corresponding details.

In the embodiment according to FIG. 5, the bearing shell 15 and the cover foil 13 each have an inner cross-section which tapers conically in the axial direction towards the bell cup 2.

In the embodiment according to FIG. 6, on the other hand, the bearing shell 15 has an internal cross-section that is essentially constant in the axial direction. However, here the cover foil 13 has an inner cross-section which tapers conically in the axial direction towards the bell cup 2.

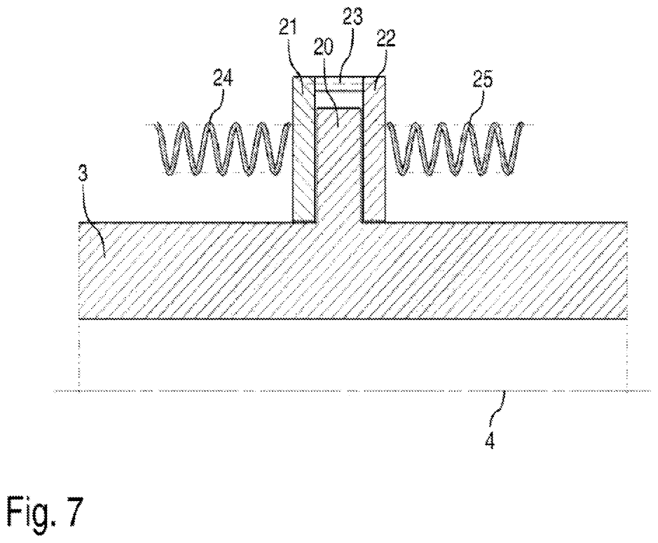

Finally, FIG. 7 shows a further embodiment of a spiral groove bearing for the turbine shaft 3 according to the disclosure, this embodiment corresponding in part to the embodiments described above, so that to avoid repetition reference is made to the above description, the same reference signs being used for corresponding individual items.

The spiral groove bearing here comprises a rotating disc 20 which projects radially from the turbine shaft 3 and rotates with the turbine shaft 3.

On both sides of the rotating disc 20 are two plane-parallel stationary discs 21, 22, which lie plane-parallel against the end faces of the rotating disc 20 and each contain a spiral groove, as is known from conventional spiral groove bearings per se.

The axial distance between the two stationary discs 21, 22 is adjusted by a spacer bolt 23 in order to reduce the starting friction.

The two stationary discs 21, 22 are preloaded by two springs 24, 25, i.e. the two springs 24, 25 press the two stationary discs 21, 22 against the rotating disc 20.

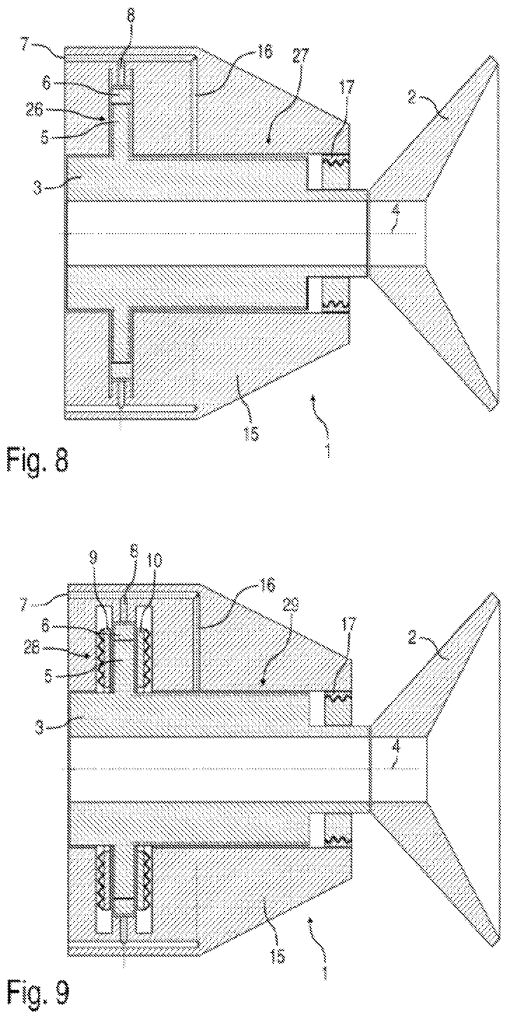

FIGS. 8-10 show various variations of the embodiment according to FIG. 1, so that in order to avoid repetition, reference is made to the above description, the same reference signs being used for corresponding details.

In the modification according to FIG. 8, a special feature is that a spiral groove bearing 26 serves as the axial bearing, while a radial bearing is formed by a further spiral groove bearing 27.

In the modification according to FIG. 9, a special feature is that a foil bearing 28 serves as the axial bearing, while a radial bearing is formed by a spiral groove bearing 29.

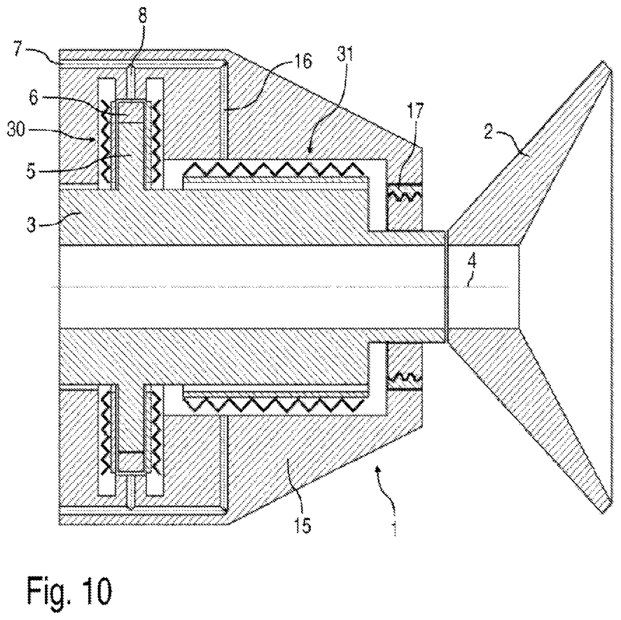

In the variation according to FIG. 10, a special feature is that a foil bearing 30 serves as the axial bearing, while a radial bearing is also formed by a foil bearing 31.

The disclosure thus permits any combination of spiral groove bearing and foil bearing as axial bearing or radial bearing.

1.-17. (canceled)

18. A bearing system for a drive turbine of a rotary atomizer for the application of a paint, with
a) a rotatable turbine shaft for receiving a bell cup which is used for spraying off the paint, and
b) a radial bearing for rotatably supporting the turbine shaft,
c) wherein the radial bearing comprises at least one bearing which is selected from a group consisting of a foil bearing and a spiral groove bearing.

19. The bearing system according to claim 18, wherein the foil bearing comprises the following:
a) a cover foil which is substantially cylindrically shaped and surrounds the turbine shaft,
b) a spring foil which is substantially cylindrically shaped and at least partially surrounds the cover foil, wherein the spring foil exerts a radially inwardly directed spring force on the cover foil, and
c) a bearing shell externally encasing the spring foil.

20. The bearing system according to claim 19, wherein
a) the spring foil has a surface stiffness of substantially 1·10⁹ N/m³±50%, and
b) the bearing shell is cylindrically shaped.

21. The bearing system according to claim 19, wherein the spring foil is selected from a group consisting of:
a) a wire mesh,
b) a bump foil with protruding bumps in the spring foil,
c) a metal foil with bent structures,
d) an elastomer foil.

22. The bearing system according to claim 19, wherein the spring foil is produced by etching.

23. The bearing system according to claim 19, wherein the cover foil is coated with a wear-reducing coating.

24. The bearing system according to claim 19, wherein the cover foil has two different radii distributed over the circumference.

25. The bearing system according to claim 18, further comprising:
a) a compressed air turbine with a rotatable turbine wheel for driving the turbine shaft,
b) a drive air supply for supplying drive air for driving the turbine wheel, and
c) an exhaust air guide for discharging the expanded drive air from the compressed air turbine.

26. The bearing system according to claim 25, wherein the drive air supply of the compressed air turbine branches off a part of the drive air and conducts it through the foil bearing.

27. The bearing system according to claim 26, wherein the branched-off drive air is guided through the foil bearing radially from the outside to the inside.

28. The bearing system according to claim 25, wherein the exhaust air guide of the compressed air turbine guides the expanded drive air at least partially through the foil bearing.

29. The bearing system according to claim 28, wherein the exhaust air guide guides the expanded drive air in the axial direction at least partially through the foil bearing.

30. The bearing system according to claim 26, wherein at least one of the spring foil and the cover foil and the bearing shell have radially through-going holes in order to guide the branched-off drive air radially from the outside to the inside.

31. The bearing system according to claim 18, wherein the radial bearing has at least two foil bearings axially one behind the other.

32. The bearing system according to claim 31, wherein a spacer ring is arranged between the adjacent foil bearings.

33. The bearing system according to claim 31, wherein the two foil bearings are arranged on different sides of the turbine wheel of the compressed air turbine.

34. The bearing system according to claim 31, wherein the two foil bearings are arranged on the same side of the turbine wheel of the compressed air turbine.

35. The bearing system according to claim 18, further comprising at least one additional axial bearing for supporting the turbine shaft.

36. The bearing system according to claim 35, the additional axial bearing having at least one spiral groove bearing.

37. The bearing system according to claim 35, wherein the additional axial bearing comprises a spiral groove bearing, while the radial bearing comprises a foil bearing.

38. The bearing system according to claim 35, wherein the additional axial bearing comprises a spiral groove bearing, while the radial bearing comprises a spiral groove bearing.

39. The bearing system according to claim 35, wherein the additional axial bearing comprises a foil bearing, while the radial bearing comprises a spiral groove bearing.

40. The bearing system according to claim 35, wherein the additional axial bearing comprises a foil bearing while the radial bearing comprises a foil bearing.

41. The bearing system according to claim 35, wherein the additional axial bearing comprises:
a) a rotating disc which is torsionally rigidly connected to the turbine shaft and rotates with the turbine shaft during operation, and
b) a first stationary disc which is arranged in a stationary manner in the bearing system, the rotating disc and the first stationary disc adjoining one another in a substantially plane-parallel manner.

42. The bearing system according to claim 35, wherein
a) the additional axial bearing has a second stationary disc which is arranged in a fixed position in the bearing system, the rotating disc and the second stationary disc adjoining one another in an essentially plane-parallel manner,
b) the two stationary discs are preferably prestressed against one another in the axial direction by at least one elastic element,

43. The bearing system according to claim 42, wherein a spacer is arranged between the two stationary discs, the spacer adjusting the axial distance between the two stationary discs in order to reduce the starting friction.

44. The bearing system according to claim 35, wherein
a) the rotational disc of the axial bearing is connected in a rotationally rigid manner to the turbine wheel of the compressed air turbine or is formed by the turbine wheel, and
b) a spiral axial bearing is arranged in the axial direction on both sides of the turbine wheel.

45. The bearing system according to claim 19, wherein the bearing shell has an inner cross-section which is essentially constant in the axial direction, while the cover film has an inner cross-section which tapers in the circumferential direction or in the axial direction towards the bell cup.

46. The bearing system according to claim 19, wherein the bearing shell and the cover film each have an inner cross section which tapers in the axial direction towards the bell cup.

47. The bearing system according to claim 18, wherein the bearing system generates frictional heat during operation at full load with a heating power of at least 50 W in order to avoid condensation in the bearing system.

48. The bearing system according to claim 19, wherein the spring foil allows a certain radial spring travel, while the spring foil has a certain bearing diameter, wherein the ratio of the spring travel and the bearing diameter is smaller than 0.1.

49. The bearing system according to claim 18, wherein
a) the bearing system has a labyrinth seal for sealing the turbine shaft,
b) the labyrinth seal surrounds the turbine shaft.

50. The bearing system according to claim 49, wherein the labyrinth seal is arranged in the axial direction between the bell cup and the radial bearing.

51. The bearing system according to claim 49, wherein the labyrinth seal has an annular or spiral groove-shaped structure.

52. The bearing system according to claim 18, wherein the radial bearing comprises an aerostatic air bearing, in which supplied compressed air builds up an air cushion for the bearing.

53. The bearing system according to claim 18, wherein the radial bearing comprises an aerodynamic air bearing, in which an air cushion for the bearing is generated by the movement of the air bearing.

54. The bearing system according to claim 18 wherein the bearing system is part of a rotatory atomizer.
